(19) United States
(12) Patent Application Publication
(10) Pub. No.: US 2007/0282815 A1
(43) Pub. Date: Dec. 6, 2007

(54) METHOD AND SYSTEM FOR STORING SEARCH TERMS IN CONNECTION WITH REGISTERED USER OF ON-LINE SEARCHING SERVICE

(75) Inventors: SUNG JA KIM, ANYANG-SI (KR); MIN YONG JUNG, SEOUL (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 11/776,460

(22) Filed: Jul. 11, 2007

Related U.S. Application Data
(63) Continuation of application No. PCT/KR2006/000156, filed on Jan. 13, 2006.

(30) Foreign Application Priority Data
Jan. 13, 2005 (KR) 10-2005-0003173

(51) Int. Cl. G06F 17/30

(52) U.S. Cl. 707/3

(57) ABSTRACT

Disclosed is a method of managing a search term inputted to a search server. The method includes maintaining a search pocket database for storing a first search term associated with a user, the first search term received from the user when the user is authenticated, receiving at least one second search term from the user when the user is not authenticated, and storing the second search term in a user terminal associated with the user, in a temporary file. The method further includes providing the second search term to the user by referring to the temporary file when the state of the user is changed from the unauthenticated state to the authenticated state, selecting at least one certain search term from the at least one second search term, according to the user's selection, and storing and managing the selected at least one certain search term in the search pocket database together with the first search term.

### CROSS-REFERENCE TO RELATED PATENT APPLICATIONS

This application is a continuation application under 35 U.S.C. § 365(c) of International Application No. PCT/KR2006/000156, filed Jan. 13, 2006 designating the United States. International Application No. PCT/KR2006/000156 was published in English as WO2006/075898 A1 on Jul. 20, 2006. This application further claims the benefit of the earlier filing dates under 35 U.S.C. § 365(b) of Korean Patent Application No. 10-2005-0003173 filed Jan. 13, 2005. This application incorporates herein by reference the International Application No. PCT/KR2006/000156 including the International Publication No. WO2006/075898 A1 and the Korean Patent Application No. 10-2005-0003173 in their entirety.

### BACKGROUND

1. Field

The present disclosure relates to search term management method and system.

2. Discussion of the Related Technology

Currently, many people use the Internet as high speed data communication network develops. As use of the Internet increases, various Internet services such as search engines, instant messengers, shopping malls, and games are provided.

In particular, since a search engine providing a search service provides various kinds of information desired by a user when the user inputs a keyword or search term, many Internet users usually use the search engine. Accordingly, to Internet users who contact information using one keyword, efficient management of keywords is a very important matter.

In keyword management methods, a keyword inputted to a search server by a user when the user does not log in the search server is stored in a user terminal of the user in a temporary file. When the user inputs a keyword to the search server by using the same terminal, the keyword stored in the temporary file is displayed to the user.

In the exemplary keyword management method, when the user inputs a keyword by using a different terminal instead of the previous terminal used for inputting a keyword, since the keyword previously inputted is not stored, the keyword inputted before by the user may not be provided. Namely, only when the user inputs a keyword by using the same terminal, the keyword inputted before may be provided.

As an alternative to the exemplary keyword management method, a method of storing and managing a keyword inputted by a user in association with the user is provided. In this method, a search server stores the keyword in association with a user identifier of the user in a predetermined storage space, which is restricted to only the keyword inputted to a search server when the user logs in to the search server. In this case, when the user logs in, the keyword stored in response to the user may be provided to the user, and though the user inputs a keyword by using a different terminal, the keyword inputted before may be provided. However, since search engine users generally search information when they do not log in a search server, there is a burden of essentially requiring log-in of the users in the method.

Consequently, cookie-based technologies which do not require authentication of users but have a defect of providing only keywords inputted by using the same terminal and conventional log-in based technologies which can provide keywords inputted in a previous search regardless of whether a terminal is the same but essentially require the log-in of the users can not satisfy desire of users to efficiently and conveniently manage the keywords inputted before by the user.

The discussion in this section is to provide general background information, and does not constitute an admission of prior art.

### SUMMARY

An aspect of the invention provides a method of processing for storing search terms used in connection with Internet-based searching, the method comprising: storing in a local computer a search term used in a search using an Internet-based searching service when the search is performed without logging-in with the service; upon logging-in from the local computer of a user with the service, inquiring to the user as to whether to have the search term stored in a server of the service in association with the user; receiving a user instruction to have the search term stored in the server; and sending the search term from the local computer to the server for storing in the server or a database with the server.

In the foregoing method, the method may further comprise monitoring searching activities of the local computer using the service with or without logging-in of a user. The method may further comprise monitoring logging-in of a user with the service from the local computer.

Another aspect of the invention provides a computer executable command for use in connection with Internet-based searching, wherein the command is to initiate a method, which comprises: determining whether a local computer stores one or more search terms used in a search using an Internet-based searching service; and displaying, on a display associated with the local computer, an inquiry as to whether to have the search term stored in a server of the service in association with a registered user of the service.

In the foregoing executable command, the command may be in the form of a JavaScript imbedded in a webpage of the service. The command may be configured to be executed upon logging-in of a user with the service or an attempt for such logging-in. The method further may further comprise: storing in the local computer a search term used in a search using the service when the search is performed without logging-in with the service; receiving a user instruction to have the search term stored in the server; and sending the search term from the local computer to the server for storing in the server or a database with the server.

An aspect of the present invention provides a keyword management method and system in which, when a user moves from the unauthenticated state to the authenticated state with respect to a predetermined search server, keywords inputted by the user when the user is not authenticated are provided to the user, and when at least one certain keyword is selected by the user from the provided keywords, the selected certain keyword is stored in a predetermined server space storing and managing the keywords inputted by the user when the user is authenticated, thereby managing two types of the keywords which differ according to whether the user is authenticated by coupling the two types of the keywords via the same server space.

An aspect of the present invention provides a keyword management method and system which enable a search server to manage not only a keyword inputted when a user is authenticated but also a keyword inputted when the user is not authenticated, thereby maximizing convenience of the user.

An aspect of the present invention provides a keyword management method and system, in which a keyword inputted from the user when a user is not authenticated is stored in the user terminal in temporary files together with search category information of the keywords and a keyword inputted from the user, when the user is authenticated, is stored and maintained in a predetermined search pocket database together with search category information of the keyword, thereby not only managing both types of the keywords to be coupled with each other but also managing the search category information of the both types of the keywords.

An aspect of the present invention provides a keyword management method and system in which a keyword inputted by a user and search category information of the keyword are stored together, thereby managing many keywords for each search category to satisfy a need of the user with respect to keyword management.

An aspect of the present invention provides a keyword management method and system in which, since keywords are managed for each search category, information on keywords frequently used by a user is provided to the user, thereby providing a service distinguished from existing services to the user.

According to an aspect of the present invention, there is provided a keyword management method of managing a keyword inputted to a search server, including: maintaining a search pocket database for storing the first keyword associated with a user, the first keyword received from the user when the user is authenticated; receiving at least one second keyword from the user when the user is not authenticated; storing the second keyword in a user terminal associated with the user, in a temporary file; providing the second keyword to the user by referring to the temporary file when the state of the user is changed from the unauthenticated state to the authenticated state; selecting at least one certain keyword from the provided at least one second keyword, according to the user's selection; and storing and managing the selected at least one certain keyword in the search pocket database together with the first keyword.

The operation of maintaining the search pocket database includes storing and maintaining search category information associated with the first keyword in the search pocket database. The operation of storing the second keyword in the user terminal associated with the user in a temporary file includes storing search category information associated with the second keyword in the temporary file. The operation of storing and managing the selected at least one certain keyword in the search pocket database together with the first keyword includes storing search category information associated with the selected at least one certain keyword in the search pocket database to be managed with the search category information associated with the first keyword.

According to another aspect of the present invention, there is provided a keyword management system for managing a keyword inputted to a search server, including: a search pocket database for storing a first keyword associated with a predetermined user, the first keyword received from the user when the user is authenticated to the user; a keyword input reception unit receiving at least one second keyword from the user when the user is not authenticated; a keyword storage unit for storing the second keyword in a user terminal associated with the user, in a temporary file; a keyword presentation unit, when the state of the user is changed from the unauthenticated state to the authenticated state, providing the second keyword to the user by referring to the temporary file; a keyword selection unit selecting at least one certain keyword from the provided at least one second keyword, according to the user's selection; and a keyword management unit for storing and managing the selected at least one certain keyword in the search pocket database together with the first keyword.

### BRIEF DESCRIPTION OF THE DRAWINGS

FIG. 1 is a diagram illustrating a network connection of a keyword management system according to an embodiment of the present invention;

FIG. 2 is a flowchart illustrating a keyword management method according to an embodiment of the present invention;

FIG. 3 is a diagram illustrating an example of a search pocket database according to an embodiment of the present invention;

FIG. 4 is a diagram illustrating an example of second keywords provided to a user, according to an embodiment of the present invention;

FIG. 5 is a diagram illustrating an example of first keywords according to an embodiment of the present invention;

FIG. 6 is a block diagram illustrating an internal configuration of the keyword management system according to an embodiment of the present invention; and

FIG. 7 is a diagram illustrating an example of a first view of managing the first keywords and the second keywords, according to an embodiment of the present invention.

### DETAILED DESCRIPTION OF EMBODIMENTS

Hereinafter, a keyword management method and system according to embodiments of the present invention will be described in detail with reference to the attached drawings. The term “keywords” in this disclosure refer to terms, words, phrases, sentences, etc. that can be used in any computerized searching.

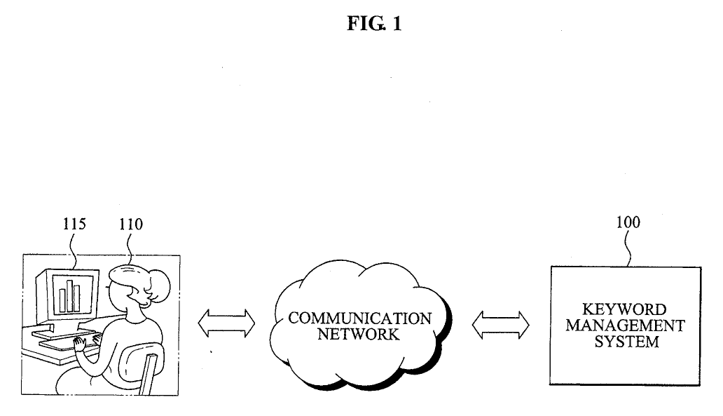

FIG. 1 is a diagram illustrating a network connection of a keyword management system 100 according to an embodiment of the present invention. The keyword management system 100 for managing a keyword inputted from a user 110 stores a keyword inputted from the user 110 when the user 110 is not authenticated in a user terminal 115, provides the keyword inputted when the user is not authenticated to the user 110 when the state of the user 110 is changed into an authenticated state, and stores and manages a certain keyword selected by the user 110 from the provided keyword.

The keyword management system 100 may be included in an Internet search service providing system for providing a predetermined search service, to be provided in association with the search service. The user 110 may have the user terminal 115 for accessing the keyword management system 100 and may input a random keyword to the keyword management system 100 via the user terminal 115. The user terminal 115 indicates a device capable of accessing a wired/wireless communication network, which is a terminal equipped with functional ability by including a memory and a microprocessor, such as a desktop PC, a notebook PC, a PDA, and a mobile communication terminal.

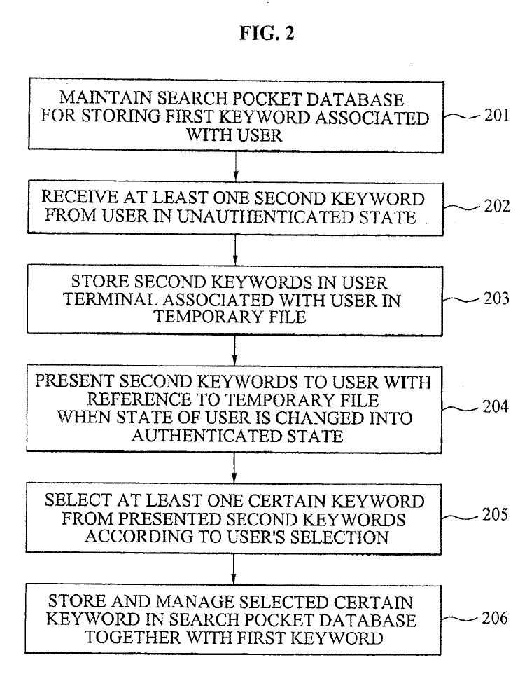

Hereinafter, a keyword management method according to an embodiment of the present invention will be described in detail with reference to FIG. 2. FIG. 2 is a flowchart illustrating the keyword management method according to an embodiment of the present invention. The keyword management method according to the present embodiment will be provided by the keyword management system 100.

In 201, the keyword management system 100 maintains a search pocket database for storing a first keyword associated with a predetermined user. The first keyword is received from the user in a state in which the user is authenticated. Namely, in the search pocket database, a keyword inputted from the user when the user is authenticated may be stored corresponding to information for identifying the user, for example, a user identifier ID. Accordingly, the keyword stored in the search pocket database may be provided to the user when the relevant user is authenticated, for example, when the user logs in a predetermined search server associated with the keyword management system 100.

Also, in the search pocket database, keyword category information associated with the first keyword may be further included. The search category information may include information on categories such as searches, news, images, geographical information, books, and movies.

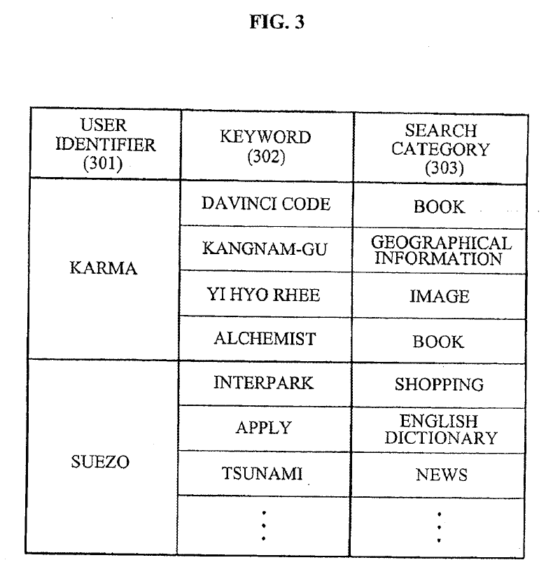

Hereinafter, the search pocket database will be described in detail with reference to FIG. 3. FIG. 3 is a diagram illustrating an example of the search pocket database according to an embodiment of the present invention. Referring to FIG. 3, the search pocket database may include a user identifier 301, a keyword 302, and search category 303. The user identifier 301 may be information for identifying the user, such as a name of the user or user ID (Identifier), etc. The keyword 302 indicates keyword information inputted from the user when the user is authenticated. The search category 303 information is associated with the keyword 302 and may include different category information in the case of the same keyword. For example, when the user inputs a keyword of “Phantom of the Opera” in a search category of “movie”, “Phantom of the Opera—movie” may be stored in the search pocket database, and when the user inputs a keyword of “Phantom of the Opera” in a search category of “book”, “Phantom of the Opera—book” may be stored in the search pocket database.

Also, a number of keywords stored in the search pocket database may be limited to a predetermined number, for example, ten, determined by a system administrator and may be flexibly changed by the system administrator. If the keywords stored in the search pocket database are more than the number, the keyword management system 100 may delete a predetermined keyword according to, for example, an order of a point in time when the keyword is stored, from the keywords stored in the search pocket database and may store a new keyword.

In 202, the keyword management system 100 receives at least one second keyword from the user when the user is not authenticated. Namely, the second keyword may be a keyword inputted from the user when the user does not log in to the predetermined search server associated with the keyword management system 100. The user may input a keyword by using a predetermined input unit such as a keyboard or a mouse of the user terminal 115 and may select search category information associated with the keyword when inputting the keyword. When the user does not select the search category information, the search category information may be automatically selected by the keyword management system 100, for example, search. Accordingly, according to a selection of the user with respect to the search category information, the search server may provide only search information corresponding to the selected search category information, to the user.

In 203, the keyword management system 100 stores the second keyword in the user terminal 115 associated with the user, in a temporary file. The temporary file may be a cookie file including information for intermediating between a user and an Internet website by storing the record of visits to the Internet website. In the temporary file, search category information associated with the first keyword may be further included.

For example, when the user inputs a random keyword in the search server and requests the search server to search, the keyword management system 100 may identify the search category information of the inputted keyword and may store a temporary file including the keyword and the identified search category information in the user terminal 115. Also, when the temporary file is stored, whether the keyword included in the temporary file is previously stored in the user terminal 115 may be checked. When the keyword is duplicated, a stored keyword may be deleted and a new keyword may be stored, or the new keyword may not be stored and the stored keyword may be maintained.

In 204, when the state of the user is changed from the unauthenticated state to the authenticated state, the keyword management system 100 presents the second keyword to the user with reference to the temporary file. For example, when the user uses a search service in the logged-out state and logs in via a predetermined log-in process, the keyword inputted from the user when the user is not authenticated may be displayed in the user terminal 115 with reference to the temporary file stored in the user terminal 115. Namely, the keyword inputted from the user when the user is not authenticated may be provided to the user when the user is authenticated so that the user can perform a search with respect to the keyword inputted from the user when the user is not authenticated. Accordingly, the user may easily perform keyword management.

Also, when the second keyword is provided to the user, the provided at least one second keyword may be provided to the user together with a predetermined button associated with each of the keywords. Accordingly, the user may select a certain button desired by the user from the provided buttons thereby selecting the keyword.

Also, when the search category information is inputted from the user, the second search term associated with the search category information corresponding to the inputted search category information may be provided to the user. Namely, the second search term associated with the inputted search category information or the second keyword associated with the related search category information may be provided to the user. For example, when the search category information inputted from the user is “movie”, if a keyword whose search category information is “movie” is not included in the temporary file stored in the user terminal 115 of the user, a keyword corresponding to search category information associated with “movie”, such as “entertainment”, may be provided to the user. In 205, at least one certain keyword is selected by the user from the provided at least one second keyword.

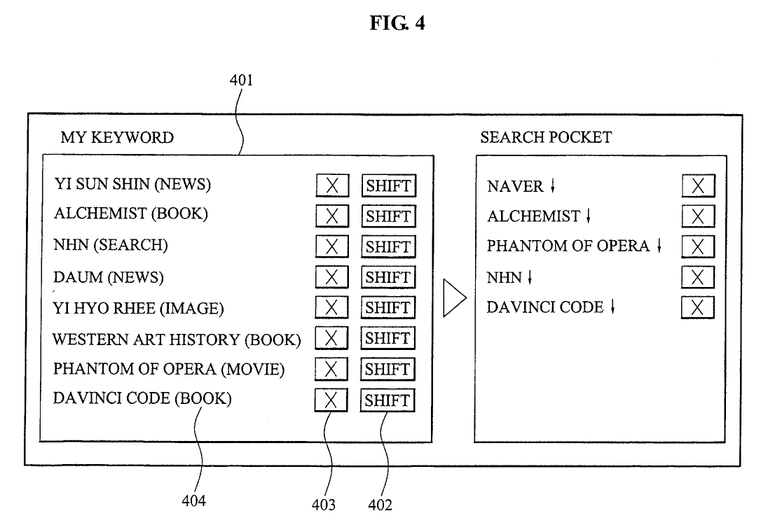

The user may select a keyword to be stored in the search pocket database by selecting a predetermined button provided together with the second keyword. Hereinafter, providing the second keywords to the user will be described in detail with reference to FIG. 4. FIG. 4 is a diagram illustrating an example of the second keywords provided to the user, according to an embodiment of the present invention.

As shown in FIG. 4, when the state of the user with respect to the predetermined search server associated with the keyword management system 100 is changed from the unauthenticated state to the authenticated state, keywords 401 inputted from the user when the user is not authenticated may be displayed in the user terminal 115 of the user to present the keywords 401 to the user. The keywords 401 inputted from the user when the user is not authenticated may be provided to the user while included in “my keyword”. Namely, the keyword and the search category information stored in the user terminal 115 of the user in the temporary file may be included in “my keyword”.

Also, together with each keyword included in “my keyword”, a shift button 402 and a delete button 403 associated with the each keyword may be provided. The user may store a keyword desired by the user in the search pocket database by clicking the shift button 403 of the keyword desired by the user from the provided keywords. Also, the keyword may be deleted by clicking the delete button 403 associated with the keyword to be deleted from the provided keywords. The deleted keyword may be deleted from the temporary file and may no longer be provided to the user.

When the shift button 403 is selected by the user, an OnClick event is generated and a predetermined function, for example, a JavaScript function, running on a web browser to process the generated OnClick event may be performed. The JavaScript function transmits the keyword and the search category information to be stored in the search pocket database to the keyword management system 100 or the predetermined search server associated with the keyword management system 100, to request to be stored in the search pocket database. The keyword management system 100 receiving the storage request may check whether the keyword and the search category information can be stored.

The keyword management system 100 receiving the storage request determines whether the user is authenticated and whether the keyword and the search category information are stored in the search pocket database in association with the user identifier of the user, in order to verify whether the keyword and the category information can be stored. When the keyword management system 100 provides the result of the determination as a variable, the JavaScript function may display the result on a predetermined display screen of the user terminal 115, with reference to the determined result information. The result may include whether the user is authenticated, a number of the keywords stored in the search pocket database, whether the keyword is duplicated, the keywords to be stored, and keyword category information.

Also, the keyword management system 100 may further present search category information 404 associated with the first keyword when the second keyword is provided to the user. Also, when certain search category information is selected by the user, only the keyword associated with the selected search category information may be provided to the user. For example, referring to FIG. 4, when the user selects “book” from the search category information, keywords whose search category information corresponds to “book”, such as “alchemist”, “western art history”, and “da Vinci code” from the keywords may be provided to the user.

Namely, when the keyword is presented to the user by using the search category information, the number of the keywords managed by the user may be increased due to the increase of the number of the keywords capable of being provided. Accordingly, the user may effectively manage many keywords.

In 206, the keyword management system 100 stores at least one certain keyword selected by the user in the search pocket database and manages the at least one certain keyword together with the first keyword. Also, the search category information associated with the selected keyword may be stored in the search pocket database and may be managed with the search category information associated with the first keyword.

As described above, the keyword inputted from the user when the user is not authenticated is stored in the user terminal in temporary files together with the search category information of the keywords and the keywords inputted from the user, when the user is authenticated, is stored and maintained in the predetermined search pocket database together with the search category information of the keyword, thereby not only managing both types of the keywords to be coupled with each other but also managing the search category information of the both types of the keywords.

The keyword stored in the search pocket database may be the keyword directly inputted from the user when the user is authenticated, or inputted from the user and selected to be stored in the search pocket database when the user is not authenticated. The keyword stored as described above may be provided to the user when the state of the user is changed from the unauthenticated state to the authenticated state.

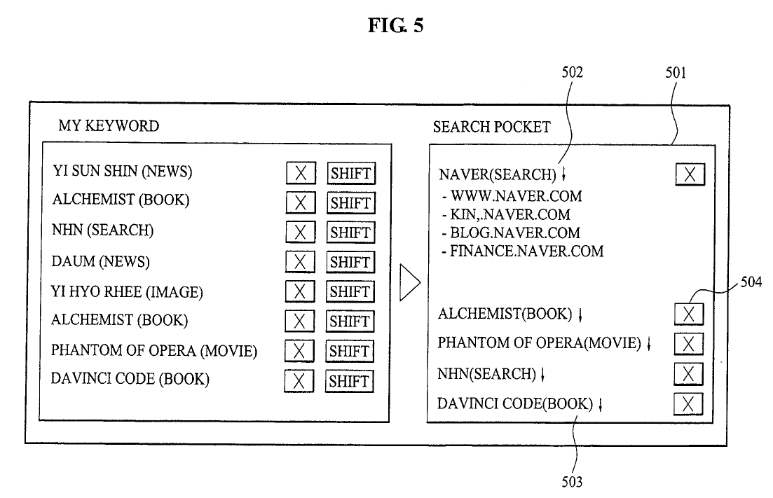

Hereinafter, the first keyword will be described in detail with reference to FIG. 5. FIG. 5 is a diagram illustrating an example of first keywords according to an embodiment of the present invention. As shown in FIG. 5, the keywords stored in the search pocket database may be provided to the user while included in a search pocket 501 that is a predetermined storage space on a web. Namely, the keyword stored in the search pocket 501 may be provided to the user via a user authentication process. The keyword stored in the search pocket 501 may be provided to the user regardless of whether the user terminal 115 of the user is the same terminal used by the user in previous search.

The keyword displayed on the search pocket 501 may be provided together with a information request button 502 providing detailed information of the keyword or a delete button 504. When the user clicks the delete button 504, the relevant displayed keyword may be omitted and may be deleted from the search pocket database. Also, when the user clicks the detailed information providing button 502, predetermined URL information associated with the keyword may be provided to the user. Accordingly, the user may visit a website associated with the relevant keyword by clicking the URL information. Also, the keyword displayed on the search pocket 501 may further include search category information 503. In the case of identical keywords whose search category information differs, the identical keywords may be managed as a different keyword, respectively.

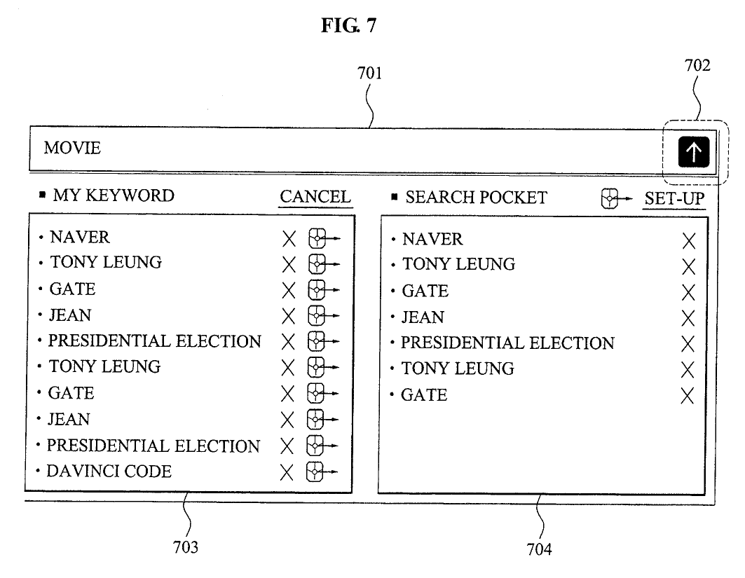

FIG. 7 is a diagram illustrating an example of a first view of managing the first keywords and the second keywords, according to an embodiment of the present invention. As shown in FIG. 7, when an authenticated user clicks a keyword management start button 702 displayed in a keyword input window 701, keywords 703 inputted by the user when the user is not authenticated and keywords 704 inputted by the user when the user is authenticated, may be provided to the user. Accordingly, the user may start a keyword management service via keyword coupling by clicking the keyword management start button 702.

In conventional technologies, “search pocket” including the keywords inputted by the user, when the user is authenticated, are provided to the authenticated user. However, “my keyword” including the keywords inputted by the user when the user is not authenticated are not provided. The keyword providing system 100 according to an embodiment of the present invention may provide not only the keywords included in “search pocket” but also the keywords included in “my keyword” may be provided to the user when the user is authenticated. Accordingly, the user may check a list of the keywords inputted when the user is not authenticated, in an authenticated state and may search by using the keywords, thereby managing the two types keywords, which differ from each other according to whether the user is authenticated, by coupling the two types of the keywords via the same server space.

As described above, when a user moves from an unauthenticated to an authenticated state with respect to a predetermined search server, keywords inputted by the user when the user is not authenticated are provided to the user, and when at least one certain keyword is selected by the user from the provided keywords, the selected certain keyword is stored in a predetermined server space storing and managing the keywords inputted by the user when the user is authenticated, thereby managing two types of the keywords, which differ according to whether the user is authenticated, by coupling the two types of the keywords via the same server space.

The keyword management method according to an embodiment of the present invention may be embodied as a program instruction capable of being executed via various computer units and may be recorded in a computer readable recording medium. The computer readable recording medium may include a program instruction, a data file, and a data structure, separately or cooperatively. The program instructions and the media may be those specially designed and constructed for the discussed embodiments of the present invention, or they may be of the kind well known and available to those skilled in the art of computer software arts. Examples of the computer readable recording medium include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter. The hardware elements above may be configured to act as one or more software modules for implementing the operations of embodiments of this invention.

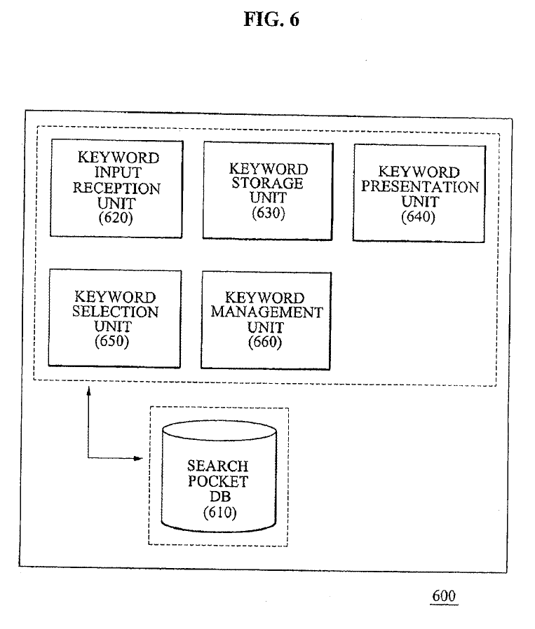

Hereinafter, a keyword management system 600 according to another embodiment of the present invention will be described. FIG. 6 is a block diagram illustrating an internal configuration of the keyword management system 600 according to an embodiment of the present invention.

As shown in FIG. 6, the keyword management system 600 may include a search pocket database 610, a keyword input reception unit 620, a keyword storage unit 630, a keyword presentation unit 640, a keyword selection unit 650, and a keyword management unit 660. The search pocket database 610 stores a first keyword associated with a predetermined user. The first keyword is received from the user when the user is authenticated. Namely, the first keyword may indicate a keyword inputted by the user when the user logs in a predetermined search server associated with the keyword management system 600.

Also, the search pocket database 610 may further store search category information associated with the first keyword. The search category information is associated with a relevant keyword and may include information, for example, searches, geographical information, movies, books, and shopping. Accordingly, the same keywords whose search category information differ from each other may be separately stored.

The keyword input reception unit 620 receives at least one second keyword from the user when the user is not authenticated. Namely, the second keyword may be a keyword inputted by the user when the user does not log in the predetermined search server associated with the keyword management system 600. The user may input the keyword by using a predetermined input unit of a user terminal.

The keyword storage unit 630 stores the second keyword in the user terminal associated with the user in a temporary file. The second keyword inputted by the user when the user is not authenticated may be stored in the user terminal in the temporary file such as a cookie file. The temporary file may further include search category information associated with the second keyword.

Also, when the second keyword inputted by the user is stored, if the second keyword is previously stored in the temporary file, the keyword storage unit 630 may delete the previously stored keyword and store the inputted keyword or may not store the inputted keyword and maintain the previously stored keyword in the temporary file. The second keyword requested to be deleted, by the user, from the provided second keywords may be deleted from the temporary file.

When the user moves from the unauthenticated to the authenticated state, the keyword presentation unit 640 provides the second keyword to the user with reference to the temporary file. Namely, if the user uses the search service by inputting a keyword when the user is not logged in and then logs in, the keyword presentation unit 640 may provide the keyword inputted by the user when the user is not logged in, to the user with reference to the temporary file. Also, when the second keyword is provided, the keyword presentation unit 640 may further provide the search category information associated with the second keyword.

The keyword selection unit 650 selects at least one certain keyword from the provided second keyword according to a selection of the user. When the second keyword is provided to the user, the keyword presentation unit 640 may further provide a predetermined button associated with each of the second keywords. Accordingly, when the button is selected, by the user, from the provided button, the keyword selection unit 650 selects a certain keyword associated with the selected button.

The keyword management unit 660 stores and manages the selected keyword in the search pocket database 610 together with the first keyword. When the second keyword selected by the keyword selection unit 650 is stored in the search pocket database 610, the keyword management unit 660 may determine whether the user is authenticated or whether the keyword to be stored is previously stored in the search pocket database 610. As a result of the determination, when the user is authenticated and the keyword is not duplicated, the keyword management unit 660 may store the selected keyword in the search pocket database 610. When the user is not authenticated or the keyword is duplicated, the keyword management unit 660 may not store the selected keyword.

Also, a keyword request by the user to be deleted from the keywords stored in the search pocket database 610 may be deleted from the search pocket database 610 by the keyword management unit 660.

Since the keyword stored in the search pocket database 610 is provided to the user when the user is authenticated, the user may search with respect to the keyword previously inputted.

While embodiments have been particularly shown and described, various changes in form and details may be made therein without departing from the spirit and scope of the invention as defined by the appended claims. The embodiments should be considered in a descriptive sense only and not for purposes of limitation. Therefore, the scope of the invention is defined by the appended claims, and all differences within the scope will be construed as being included in the scope of the present invention.

According to embodiments of the present invention, there is provided a keyword management method and system in which, when a user moves from the unauthenticated to the authenticated state with respect to a predetermined search server, keywords inputted by the user when the user is not authenticated are provided to the user, and when at least one certain keyword is selected by the user from the provided keywords, the selected certain keyword is stored in a predetermined server space storing and managing the keywords inputted by the user when the user is authenticated, thereby managing two types of the keywords differently, according to whether the user is authenticated, by coupling the two types of the keywords via the same server space.

According to embodiments of the present invention, there is also provided a keyword management method and system which enable a search server to manage not only a keyword inputted when a user is authenticated but also a keyword inputted when the user is not authenticated, thereby maximizing convenience of the user.

According to embodiments of the present invention, there is also provided a keyword management method and system in which a keyword inputted from the user when a user is not authenticated is stored in the user terminal in temporary files together with search category information of the keywords and a keyword inputted from the user, when the user is authenticated, is stored and maintained in the predetermined search pocket database together with search category information of the keyword, thereby not only managing both types of the keywords to be coupled with each other but also managing the search category information of the both types of the keywords.

According to embodiments of the present invention, there is also provided a keyword management method and system in which a keyword inputted by a user and search category information of the keyword are stored together, thereby managing many keywords for each search category to satisfy the needs of the user with respect to keyword management.

According to embodiments of the present invention, there is also provided a keyword management method and system in which, since keywords are managed for each search category, information on keywords frequently used by a user is provided to the user, thereby providing a service distinguished from existing services to the user.

What is claimed is:

1. A search term management method, comprising:
providing an on-line searching service allowing both a non-authenticated access and an authenticated access to the searching service;
receiving a first search term for a first search from a registered user of the on-line searching service while the user is in the authenticated access;
storing the first search term in a search database associated with the searching service, wherein the first search term is stored in connection with the user;
receiving a second search term for a second search from a terminal associated with the user while the user is in the non-authenticated access;
storing the second search term in the terminal;
inquiring to the user whether to store the second search term in the search database when the user makes an authenticated access to the searching service from the terminal; and
storing the second search term in the search database when user chooses to store the second search term, wherein the second search term is stored in connection with the user.

2. The method of claim 1, wherein the search database further stores first additional information that is obtained from the first search using the first search term;
wherein the method further comprises storing in the terminal second additional information that is obtained in the second search using the second search term; and
wherein the method further comprise storing in the search database at least part of the second additional information.

3. The method of claim 2, wherein upon making the authenticated access, inquiring whether to store the second search term is initiated when the user selects at least part of the second additional information.

4. The method of claim 1, wherein inquiring comprises displaying the second search term with a selection button configured to select the second search term for storing in the search database.

5. The method of claim 4, further comprising:
transmitting to the search database the second search term and additional information that is obtained in the second search that is stored in the terminal;
receiving, by the search database, the second search term; and
prior to storing in the search database, checking whether the second term is allowed to be stored in the search database.

6. The method of claim 5, wherein checking comprises at least one of:
determining whether the user is authenticated at the time of receipt of the second search term; and
determining whether the second term is already stored in the search database in connection with the user.

7. The method of claim 6, wherein subsequent to checking, the search database provide the terminal with at least one of the following:
whether the user is authenticated;
the number of the search terms currently stored in the search database in connection with the user;
whether the second search term is already stored in the search database in connection with the user;
the first search term and other search terms currently stored in the search database in connection with the user; and
the first additional information and other information associated with the other search terms.

8. A computer readable recording medium in which a program for executing the method according to claim 1.

9. A system for managing search terms in connection with a user conducting on-line searching, comprising:
a search database associated with an on-line searching service, the search database being configured to store search terms in connection with a user;
a search term reception unit configured to receive search terms from a user terminal while the user is in an authenticated access to the searching service;
a search term storage unit in the user terminal, the search term storage unit being configured to store search terms that are used for searching while the user is in an unauthenticated access to the searching service;
a search term presentation unit configured to providing the user with information relating to search terms stored in the search term storage unit when the user terminal is turning to an authenticated access to the searching service;
a search term selection unit configured to let the user select at least part of the search terms stored in the search term storage unit; and
a search term management unit configured to coordinate storing of the selected search term in the search database in connection with the user.

10. The system of claim 9, wherein the search database is configured to further store additional information in association with search terms stored therein, and wherein the user terminal is configured to further store additional information that is obtained from a search conducted using a search term while the user is in an unauthenticated access to the searching service; and
wherein the search term management unit configured to further coordinate storing in the search database the additional information from the user terminal.

11. A method of processing for storing search terms used in connection with Internet-based searching, the method comprising:
storing in a local computer a search term used in a search using an Internet-based searching service when the search is performed without logging-in with the service;
upon logging-in from the local computer of a user with the service, inquiring to the user as to whether to have the search term stored in a server of the service in association with the user;
receiving a user instruction to have the search term stored in the server; and
sending the search term from the local computer to the server for storing in the server or a database with the server.

12. The method of claim 11, further comprising:
monitoring searching activities of the local computer using the service with or without logging-in of a user.

13. The method of claim 11, further comprising:
monitoring logging-in of a user with the service from the local computer.

14. A computer executable command for use in connection with Internet-based searching, wherein the command is to initiate a method, which comprises:
determining whether a local computer stores one or more search terms used in a search using an Internet-based searching service; and
displaying, on a display associated with the local computer, an inquiry as to whether to have the search term stored in a server of the service in association with a registered user of the service.

15. The command of claim 14, wherein the command is in the form of a JavaScript imbedded in a webpage of the service.

16. The command of claim 14, wherein the command is configured to be executed upon logging-in of a user with the service or an attempt for such logging-in.

17. The command of claim 14, wherein the method further comprises:
storing in the local computer a search term used in a search using the service when the search is performed without logging-in with the service;
receiving a user instruction to have the search term stored in the server; and
sending the search term from the local computer to the server for storing in the server or a database with the server.
